(19) United States
(12) Patent Application Publication
(10) Pub. No.: US 2019/0136949 A1
(43) Pub. Date: May 9, 2019

(54) Electronic, Remote Control, Automation Method for Maneuvering Machine with Internal Combustion Engine

(71) Applicant: Reza Khayatian, Teaneck, NJ (US)

(72) Inventor: Reza Khayatian, Teaneck, NJ (US)

(21) Appl. No.: 16/182,599

(22) Filed: Nov. 6, 2018

Related U.S. Application Data
(60) Provisional application No. 62/581,804, filed on Nov. 6, 2017.

(51) Int. Cl. F16H 37/06; F16H 7/02; F16H 7/06; F16H 15/46; F16H 63/04; F16H 63/30; F16H 21/44

(52) U.S. Cl. CPC F16H 37/065; F16H 7/02; F16H 7/06; F16H 15/46; B62D 11/10; F16H 63/302; F16H 21/44; F16H 2063/305; F16H 63/04

(57) ABSTRACT

The device embodied in the present invention utilizes the lateral rotation produced by a motor, which may be an internal combustion engine or an electrical motor. The lateral rotation is outputted directed unto the main crankshaft of an engine. A main pulley is mounted onto said main shaft and rotates with the same revolution rate as the motor, or at a reduced revolution rate, depending on the diameter of the main pulley and whether additional steps and hears are utilized to reduce or step down the rotary forces.

### CLAIM OF PRIORITY

This application claims prior of the U.S. Provisional Patent Application No. 62/581,804 filed on Nov. 6^{th}, 2018, the contents of which are fully incorporated herein by reference.

### FIELD OF THE INVENTION

The present invention relates to a simple propulsion mechanism for devices driven by an onboard engine, which may be engaged remotely.

### BACKGROUND OF THE INVENTION

Robotics has made great progress, and some of the most sophisticated maneuvers and operations are now handled by machines. One of the present frontiers of robotic technology deals with self-propelled vehicles of all types. There is presently a race to fully automate passenger transportation for hire. The technology is being test in many markets and packages with varying degree of success.

The common denominator of nearly all self-propelled devices, is a relatively complex transmission of power to the drive wheels, complicated even further by a sophisticated steering mechanism, requiring an on-board computer to direct operation of devices.

While sophistication is a positive development, it also has led to dramatic increases of production costs, which in turn has raised prices for an end consumer. The present invention maintains the momentum and benefits of automation, managing to retain the simplicity and low cost of a human-operated analogous device.

The device disclosed in the present invention taps into the rotary power of an existing internal engine and transmits this power to the drive wheels in a way in which directional of the device's linear motion is easily controlled without needing to resort to complex transmission and reduction systems. While the embodiment demonstrated is a modified lawn mower, similar concepts of automation may be applied to other devices, such as robotic delivery and transportations devices.

### SUMMARY OF THE INVENTION

The device embodied in the present invention utilizes the lateral rotation produced by a motor, which may be an internal combustion engine or an electrical motor. The lateral rotation is outputted directed unto the main crankshaft of an engine. A main pulley is mounted onto said main shaft and, rotates with the same revolution rate as the motor, or at a reduced revolution rate, depending on the diameter of the main pulley and whether additional steps and hears arc utilized to reduce or step down the rotary forces.

Through a belt or chain drive, the rotation of the main pulley is transmitted to pulleys that are, in direct contact with wheels, or with structures that are connected to the wheels. The secondary pulley, or a pair of pulleys is each connected to shafts having an upper and lower friction wheel. The upper and lower friction wheels connected to a friction disk that is connected directly to a device wheel or is connected to a device wheel through a transmission device. The upper and, lower friction wheels face are coupled with an external face of a vertical friction disk, being substantially perpendicular to it. Thus a connection to a friction disk by an upper friction wheel will produce a rotation of the friction disk than a connection by the lower friction wheel to the friction disk. The distance separating the upper and lower friction wheels along the secondary shafts serves to regulate the speed of the device.

The friction disk is driven alternatively by either the lower frinction disk or the upper friction disk. The connection is switched with the help of a solenoid device which orients the fiction disk with either the lower or the upper friction wheel

In another embodiment, a clutch cylinder rides linearly along the drive shaft of a drive pulley and is coupled with either the lower or the upper drive wheels. Once the connection between a clutch cylinder and a friction wheel is established, the friction disk begins to rotate in the direction influenced by the friction wheel. The meshing of a clutch cylinder with a specific fiction wheel is controlled by an arm whose angle is controlled by a solenoid. Thus the direction of travel of a device controlled relying on the drivetrain disclosed in the present invention is controlled by orienting the friction disk with the appropriate friction wheel on both left and fright wheels of the same axle, which will induce the desired direction of travel. The orientation of the friction disk or the meshing of the clutch cylinder is controlled by an arm emanating from a solenoid. which can in turn be stirred remotely or autonomously.

### BRIEF DESCRIPTION OF THE DRAWINGS

FIG. 1 is a top view.

FIG. 2 is a top view of an alternative embodiment.

FIGS. 3, 4, 5A and 5B demonstrate one embodiment of the devices disclosed in the present invention, demonstrating directional control and steering.

FIGS. 5C, 5D and 6 provide a context for the device disclosed in the previous figures.

FIGS. 7, 8, 9 and 10 demonstrate another alternative embodiment if the disclosed method. FIGS. 10a, 10b and 11 provide a context for the device disclosed in FIGS. 7-10.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. in fact, those of ordinary skill in the art may appreciate upon reading the present specification and viewing the present drawings that various modifications and variations 10 can be made thereto.

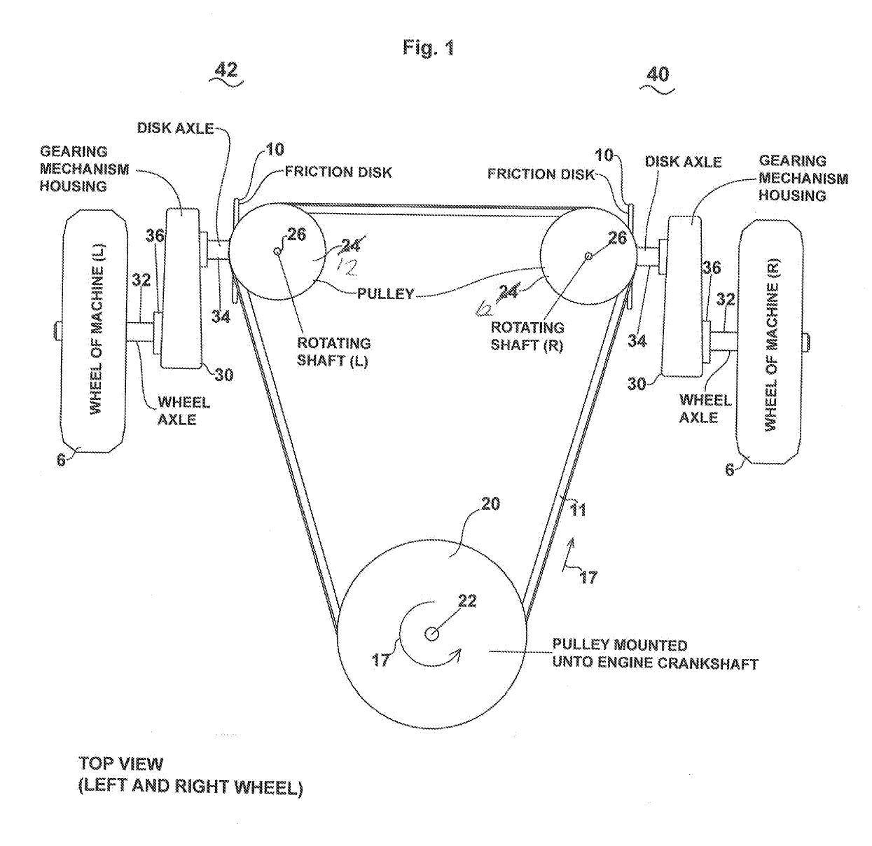

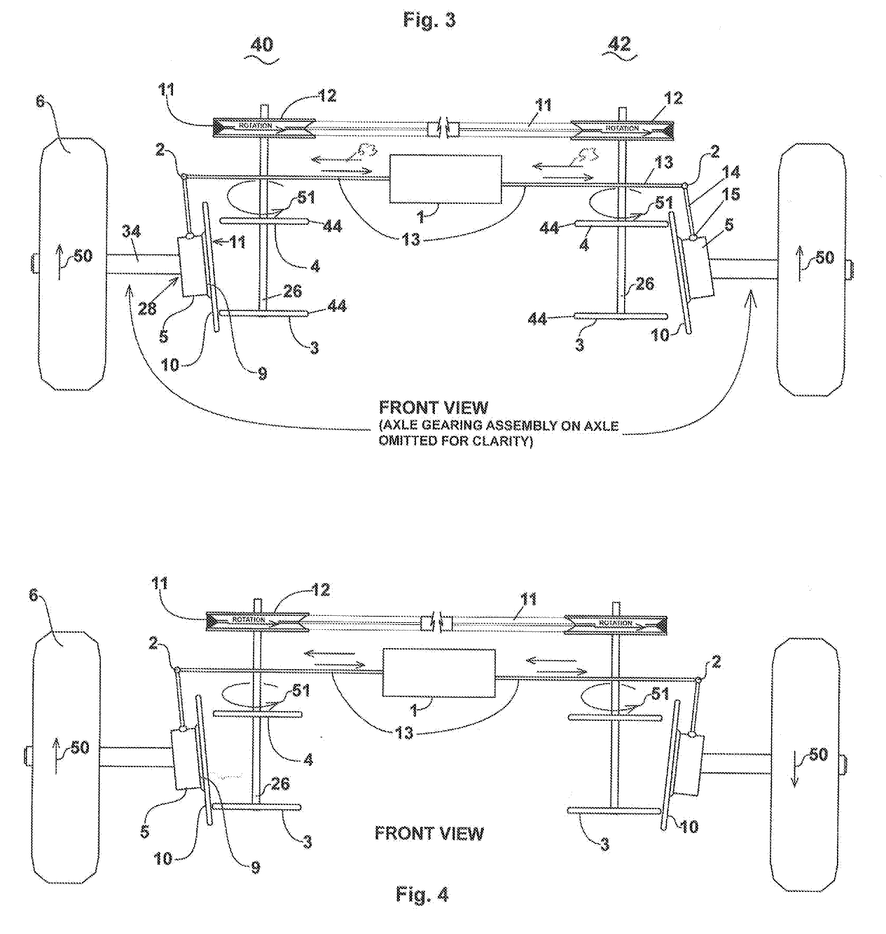

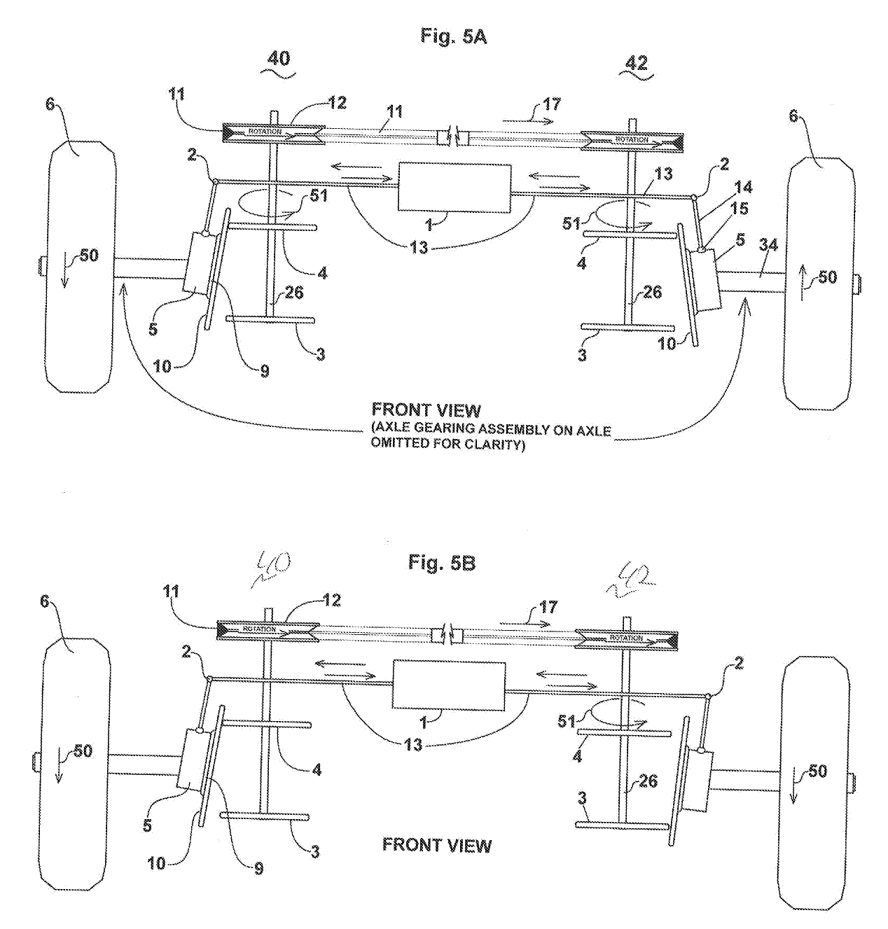

Turning now descriptively to the drawings, in which similar reference characters denote similar elements throughout the several, views, the figures illustrate several embodiments of a method of directional and steering control of a device powered by an onboard engine 70 (FIG. 11). FIG. 1 is a top view of the present invention. Shown is the crankshaft 22, main pulley 20, drive belt 11. A right drive wheel assembly 40 and a left drive wheel assembly having at least one drive pulley 12, each rotating a drive shaft 26. A friction disk 10 engaging friction wheels 3 and 4 (FIGS. 3 and 4). Said friction disk 10 connecting to a gearing mechanism 30 through a disk axle 34. Said gearing mechanism transmitting rotational force to machine wheels 6 through the wheel axles 32. The diameter 25 of the main pulley and the diameter 29 of the drive pulleys 12 is varied based on optimal desired speed of the disclosed device. Increasing or decreasing diamters 25 and 29 will have the effect of forcing the drive wheels move slower or faster. Additional speed control is performed inside the gearing mechanism 30 connected to each drive wheel 6. While FIG. 1 demonstrates a left and right drive wheel assembly 42 and 40, only one assembly is required to induce forward and reverse locomotion of the disclosed device. Also shown in FIG. 1 are gasket sockets 36 containing lubrication and ball bearings. The device is shown moving the drive belt 11 in the direction 17. The single direction of promotional is due to the basic oscillation motion of the crankshaft 22 that is induced by an engine assembly 70.

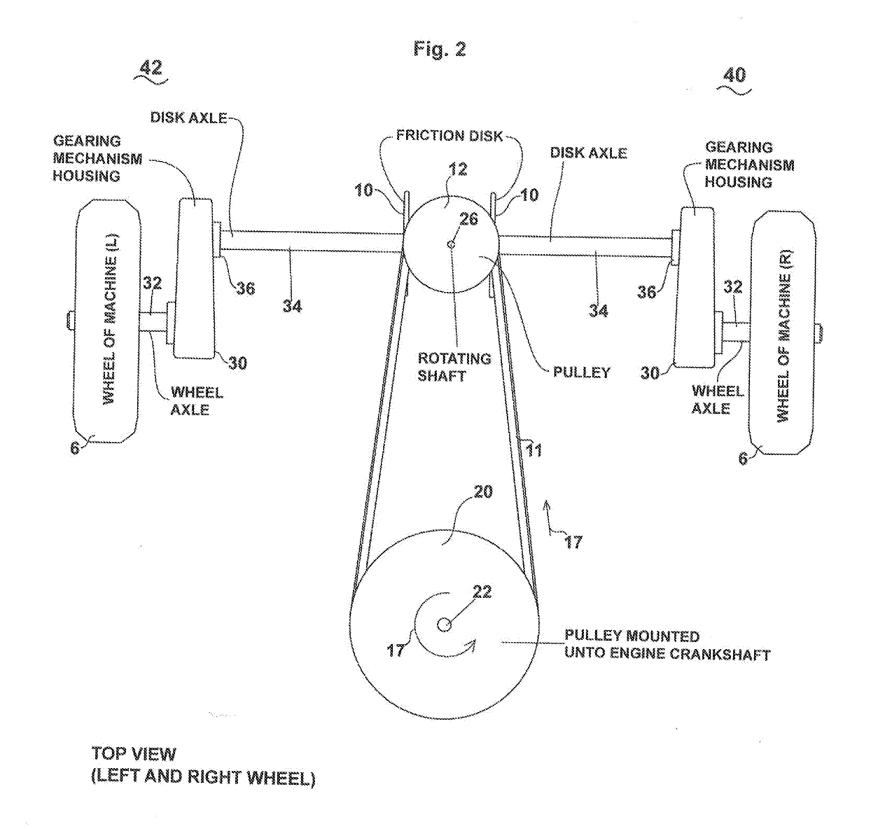

FIG. 2 demonstrates an alternative embodiment of the disclosed device. Shown is the main pulley 20, connected in a fused coupling with the crankshaft 20, which drives the belt or chain 11. The disclosed pulleys 12 and may be spur gears driving a chain 11. FIG. ,2 demonstrates that the device may be propelled and controlling using just one drive pulley assembly 33. having a pulley 12 being in a fused coupling with a drive shaft 26. The disk axles 34 each bearing a friction disk at their proximal ends 37 and connecting to a gearing mechanism 30 at their proximal ends 39. The gearing mechanism then connects to the drive wheel 6 through wheel axles 32. The frictional disk 10 abuts the central drive pulley 12 on either side. The direction of rotation of each drive wheel assembly 40 and 42 is determined by the coupling of the frictional disks 10 to frictional wheels, as shown in later figures.

FIGS. 3, 4, 5A and 5B demonstrate the steering and directional mechanisms disclosed in the present invention. Shown in FIGS. 3 and 4 is the solenoid device 1 controlling thrusters 13 existing from either side of the solenoid 1. Alternatively, each drive wheel assembly 40 and 42 may be controlled by a separate solenoid 1. The solenoid 1 received commands from a remote source which may send radio signals to a radio wave receiver on board the solenoid 1 or a device in direct communication with the solenoid 1. The solenoid 1 may derive power from a battery source, or may convert kinetic energy from rotation of the shafts 12.

FIG. 3 shows that the thruster arm 13 on either side is driven in the direction to the right 53. Each thruster arm 13 is hinged along its length into an elbow 2 to permit clearance over the frictional disk 10. The second portion 14 of the thruster arm 14 connects at point 15 to the body of the tilting cylinder 5. The frictional disc 10 is connected to a wheel shaft 32 through a tilting cylinder 5. The titling cylinder 5 connects to the wheel axle 32 through a universal joint 28.

In the embodiment shown in FIGS. 3 and 4, the frictional disk shown to be distanced by several millimeters from the upper frictional wheel 4 and the lower frictional wheel 3. The upper frictional wheel 4 is located along a length of the drive shaft 26 in a perpendicular 10 orientation with the shaft 26. The lower frictional wheel 3 is located at the terminal end 57 of the drive shaft 26. The coupling surfaces 44 of the upper and lower frictional wheels 4 and 3 are in an alternating tight frictional association with the face 11 of the frictional disk 10.

The view of FIGS. 3, 4, 5A and 5B is from the front of the entire axle suspension assembly. FIG. 3 demonstrates reverse motion of the drive wheels 6. This is accomplished having the frictional disk 10 of the right wheel assembly 40 meshing with the lower frictional wheel 3 of the assembly, while the frictional disk 10 of the left wheel assembly 42 meshing with the upper frictional wheel 4 of the left wheel assembly 42. This causes both frictional discs 10 to rotate in the same direction 50, namely in the reverse, translating the same motion to the drive wheels 6 through the wheel axles 32. The tilt of the tiling cylinder 5 is promoted by the second portion 14 of the thruster arm 13, which then translated to the frictional disk 10 through a ball bearing connection 9 between the tiling cylinder 5 and the frictional disk 10.

In FIG. 4. the thruster arm 13 associated with the right wheel assembly 40 is driven in the rightward direction 53, while the thruster arm 13 associated with the left wheel assembly 42 is driven in the leftward direction 55. This results in tilting cylinders 5 and frictional disks 10 tilting to mesh with the lower frictional wheel 3, forcing the drive disks 10 to rotate in opposite directions 50, namely toward the right.

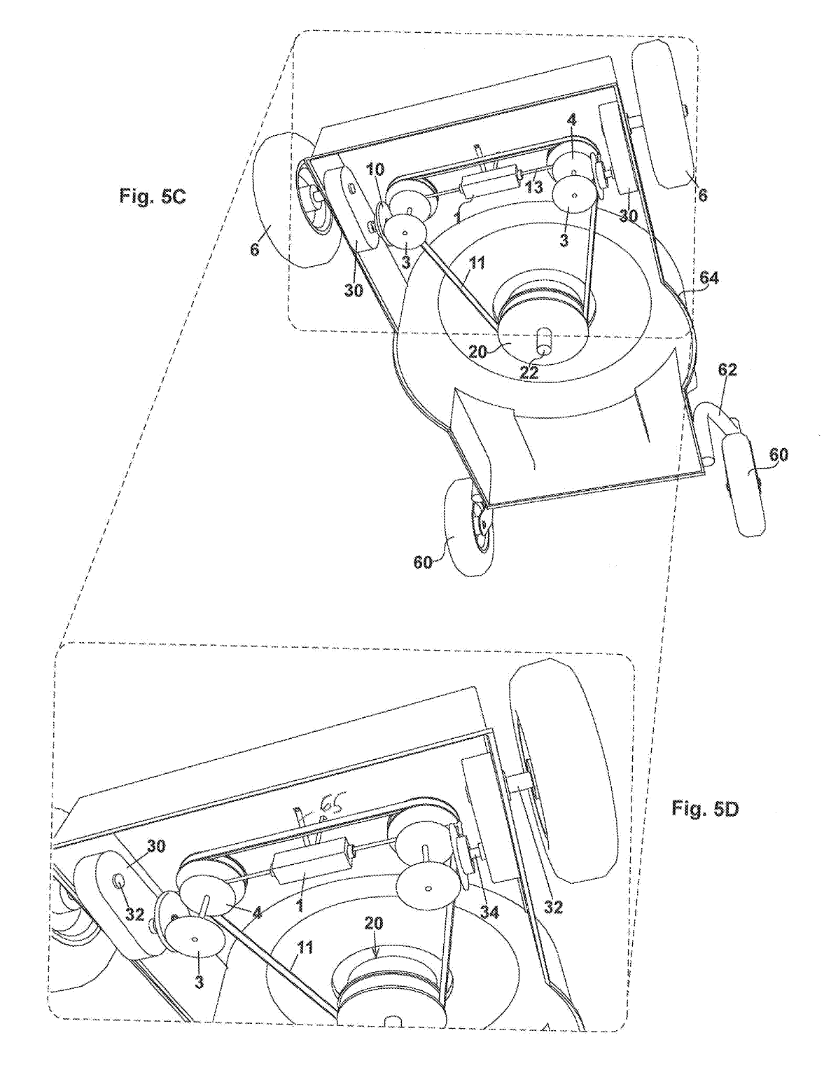

In FIG. 5A, the thruster arm 13 associated with the right wheel assembly 40 is driven in the leftward direction 55, while the thruster arm 13 associated with the left wheel assembly 42 is driven in the rightward direction 53. This results in frictional disks 10 of both left and right assemblies 42 and 40 to mesh with the upper frictional wheels 4 of the drive shafts 26, causing the frictional disks 10 to rotate in opposite directions 50, namely to the left.

Finally, in FIG. 5B, the orientation of frictional disks 10 of the right and left drive wheel assemblies 40 and 42 is the opposite of that shown in FIG. 3. Therefore, if FIG. 3 the rotation of the wheels was in the reverse direction 50, the rotation of the wheels 6 in FIG. 4 is the forward direction 50. For a fully autonomous device, it is possible to force the device to near complete stop by rapidly alternating the thruster arms in the direction 53 then 55, causing the frictional disks 10 and in turn the drive wheels 6 to alternate between reverse and forward directions at a very rapid rate, effectively standing still. Alternatively, a stop or lack of motion of the device may also be caused by momentarily decoupling either the drive shafts or the crankshaft 22 from the pulleys 12 and respectively. This can be done by inserting a ratcheting gasket in a spot where the drive pulleys 12 meet the drive shafts 26 or where the crankshaft meets the main pulley 20. The ratcheting gasket may then be caused to decouple the pulley from shaft causing a neutral state of motion, resulting in eventual or immediate stoppage. The same may be done to force a turn to left or right by alternatively placing either the right 40 or left 42 assemblies in a neutral ratcheting position, preferably by electronically enabling or disabling left or right assemblies 42 or 40 respectively.

FIGS. 5C and 5D demonstrate the context of the device assembly shown in FIGS. 3, 4, 5A and 5B. Shown is a lawn mower 64. The crankshaft 22 is connected to the main pulley 20, which transmits the rotation of the crankshaft 22 to the drive shafts 26 using the belt or chain 11. The solenoid I then controls the pitch of the frictional disk 10, which then determines which frictional drive wheel 3 or 4 is being engaged. Since the coupling surface 44 runs along the face of the frictional disk 11, it pushes the frictional disk 11 to rotate in the 10 direction of least resistance. namely forward or in reverse. Alternating the directions 50 causes the device to turn either right or left or move straight ahead or in reverse. The rear wheels 60 preferably have castor type assembly 62 causing to offer the lease resistance to the steering method>where one wheel is turned one way and the other in an opposing direction 50.

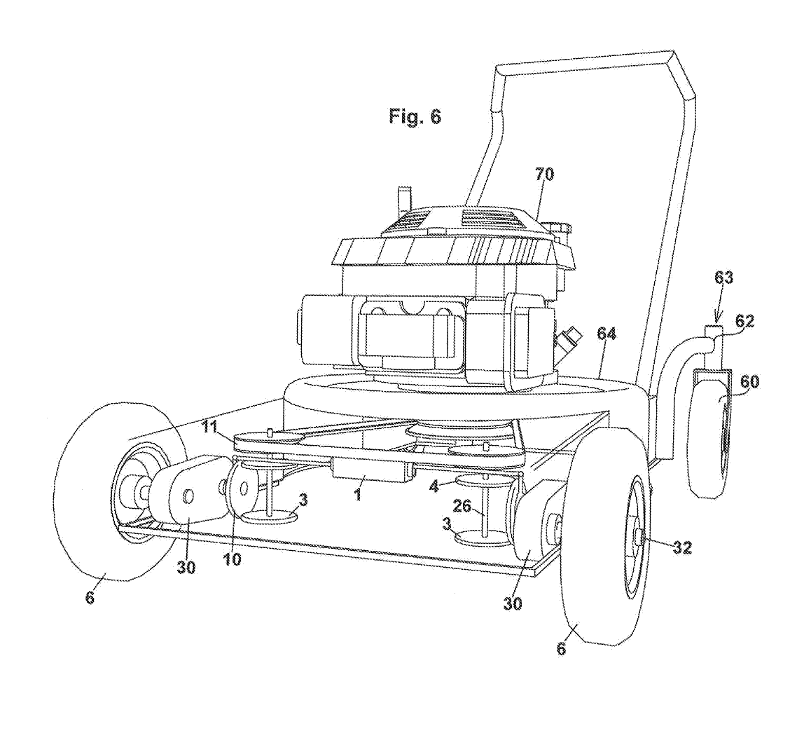

The engine 70 shown in FIGS. 6 and 11 is a single or dual cylinder internal combustion engine, however any other engine type, including an electrical engine my be used to empower the same or similar device as shown in FIGS. 6 and 11. The solenoid 1 mounts to the undercarriage of the corpus 64. The rear wheels 60 are preferably free spinning castor type wheel having an axle 63 mounted perpendicularly on a mounting arch 62.

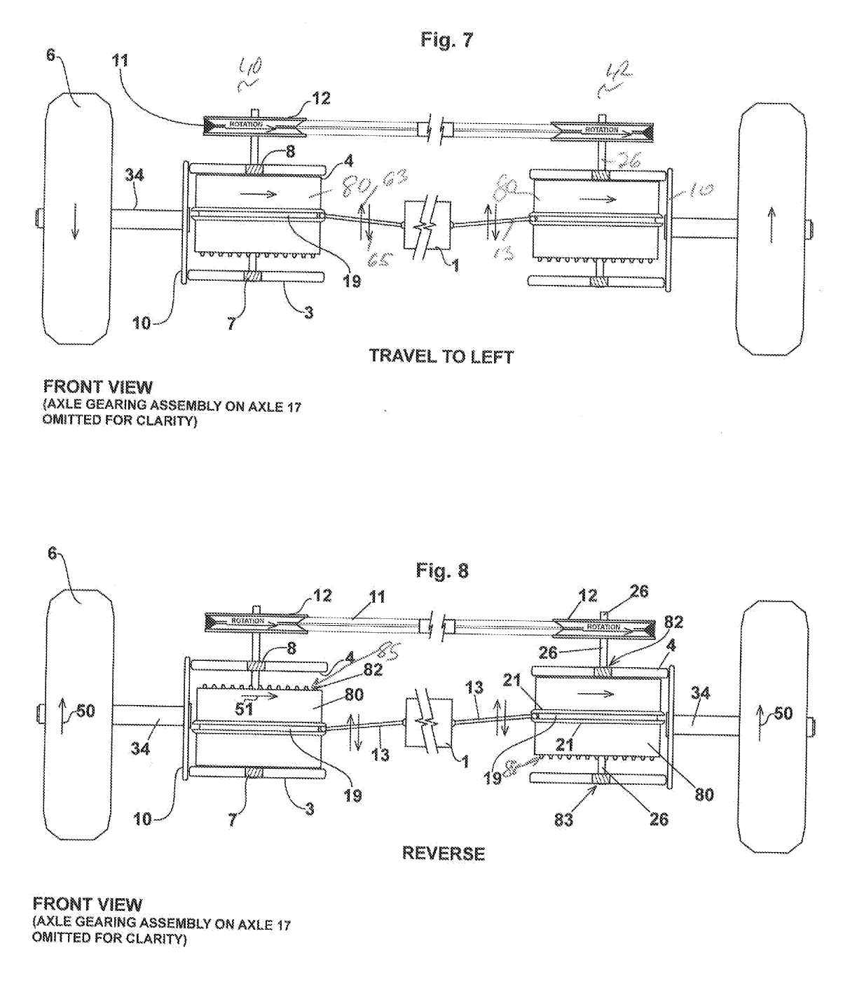

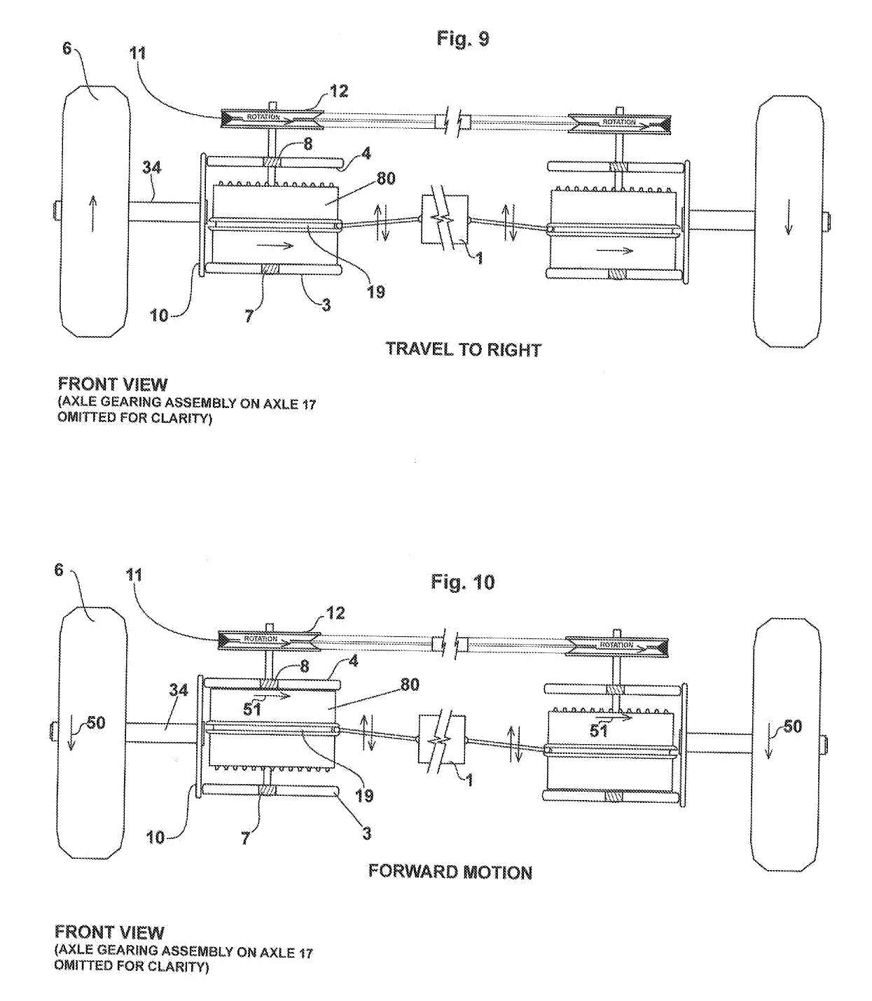

FIGS. 7, 8, 9 and 10 demonstrate an alternative embodiment. The FIGS. 7-10 are still showing the front view of the front axle assembly. Shown are the drive pulleys 12, rotated by the chain or belt 11, which rotates the drive shaft 26 coupled with each drive pulley 12. The upper frictional wheel 4 and the lower frictional wheel 3 are rotating independently of the shaft 28 through a ball bearing gasket shown as items 7, 8, 82 and 83 in FIGS. 7 and 8. The frictional disks 10 are in tight and constant association with both upper and lower frictional wheels 4 and 3. The ratchet cylinder 80 rotates together with the shaft 26 and also slides linearly in the upward direction 63 and in downward direction 65, as propelled by the thruster arms 13.

The thruster arms 13 are stretched between a solenoid 1 on one side and the sidewall track 19 of the ratchet cylinder 80 on the other end. The connection between the thruster arm 13 has a hinge 91 on both the solenoid side 1 and within the sidewall track 19. The thruster arm 13 is stationery and glides along the track 19 while the ratchet cylinder rotates with the shaft 26.

Shown in FIGS. 7 and 8 the upper face 85 of the ratchet cylinder 80 contains teeth 82 and the lower face 88 contains teeth 82. The teeth 82 serve as crown or rack and pinion type gears in association with upper and lower frictional wheels 4 and 3. Similarly, the fictional face 44 of FIGS. 3 and 4 may be a spur gear.

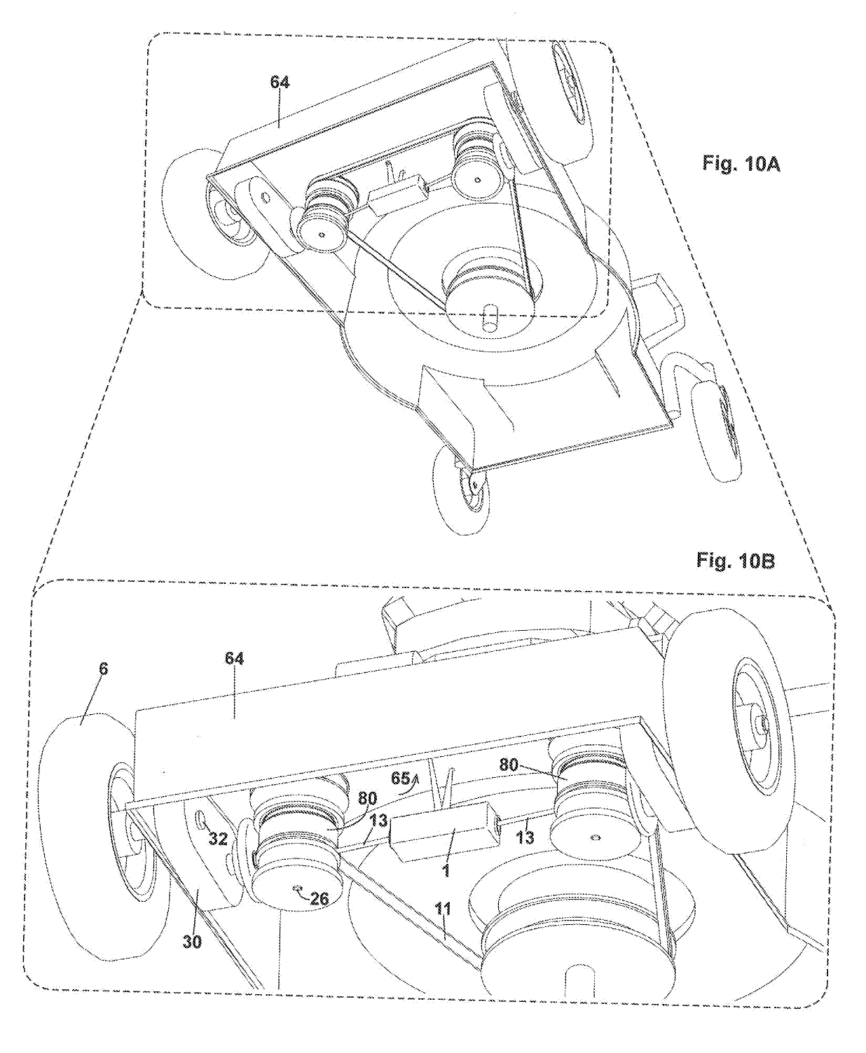

To propel the assembly in the right direction as shown in FIG. 7 the ratchet cylinder 80 on the right drive assembly 40 is driven up by the thruster arm 13, meshing with the upper frictional wheel 4. The upper frictional wheel 4 begins to rotate in the, same direction as drive shaft 26, forcing the left wheel 6 to rotate through the rotation of the frictional disk 10 in the forward direction 50. At the same time, the thruster arm 13 associated with the left assembly 42 is thrust upwards meshing with the upper frictional wheel 4 of the left drive assembly 42, forcing the frictional disk 10 and the drive wheel to rotate in the opposite direction 50, producing a leftward turn. FIG. 9 is the opposite of FIG. 7. There the downward direction 65 thrust of the ratchet cylinders 80 on both left assembly 42 and the right assembly 40 produces rotation 50 to the right.

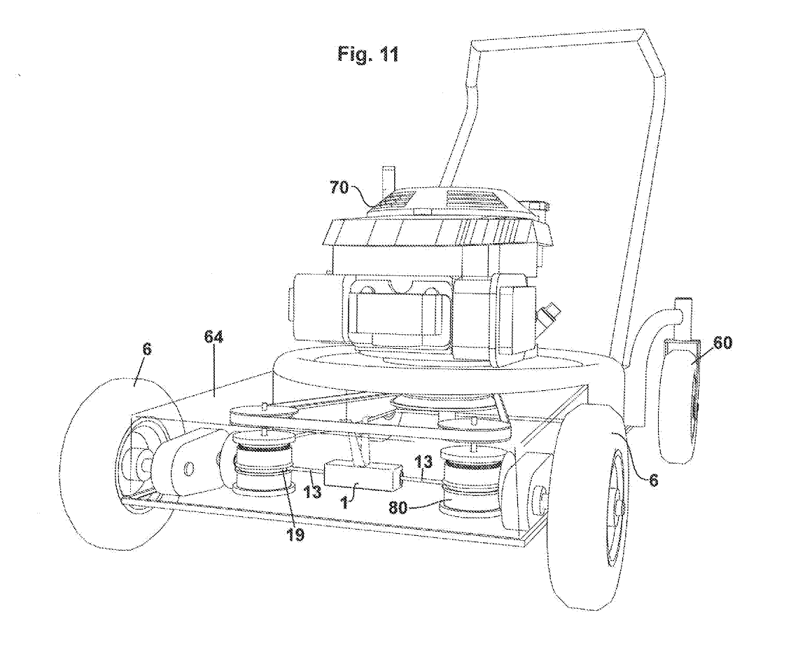

FIGS. 8 and 10 illustrate reverse and forward motions respectively. In each, case the ratchet cylinder 80 meshes with a frictional wheel 3 or 4 on one of the drive assemblies 42 or 40 that is diagonal to the frictional wheel 3 or 4 on the opposite drive assembly 40 or 42. Thus to go forward the ratchet cylinder 80 of the right assembly would mesh With the upper frictional wheel 4, while the ratchet cylinder 80 of the left assembly 42 would mesh with the lower frictional wheel 3. The reverse meshing combination is true in FIG. 8 to induce a motion in the reverse.

FIGS. 10A, 10B and 11 demonstrate the embodiment shown in FIGS. 7-10 in context of a full device that may be propelled autonomously and steered by turning the drive wheels 6 in opposite directions. The figs show one solenoid 1 connected to the undercarriage of the corpus 64 with a bracket 65. Alternatively, each drive wheel assembly 40 or 42 would have its own solenoid 1. The electrical impulses into the solenoid 1 may be produced via a remote connection as would be appreciated by one skilled in the art. It is also appreciated in the art that if the pulleys and 12 were rotating in the direction opposite to direction 17, the directional description would the correspondingly opposite direction then as shown and described above.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A propulsion mechanism comprising, a crankshaft connecting to a motor, said crankshaft having a main pulley; a ribbon linking said main pulley with at least one drive pulley; said at least one drive pulley having a drive shaft; said drive shaft having an upper frictional wheel along a length of said drive shaft and a lower frictional wheel at a terminal end of said drive shaft; said upper and said lower frictional wheels being in perpendicular orientation with said drive shaft; a frictional disk, said fictional disk connecting to an axle to a left wheel and an opposing frictional disk connecting to an axle of a right wheel opposite said left wheel, wherein said frictional disk and said opposing frictional disk independently couple with said upper frictional wheel or said lower frictional wheel; wherein said frictional disk being in a perpendicular orientation with said upper and said, lower frictional wheels; and a tiling cylinder connecting to said fictional disk, wherein said tilting disk causing a face, of said frictional disk to altematingly couple with said upper and said lower frictional wheel.

2. The propulsion mechanism of claim 1, further comprising a solenoid, said solenoid having a thruster arm emanating from it and terminating m a body of said tilting cylinder of said frictional cylinder of said frictional disk and a frictional cylinder of said opposing frictional disk; wherein thrusts of said thrusting arm induced by said solenoid cause said tilting disks to alternatively couple said frictional cylinder or said opposing frictional cylinder with said upper or lower frictional wheel.

3. A propulsion mechanism comprising, a crankshaft connecting to a motor, said crankshaft having a main pulley; a ribbon linking said main pulley with at least one drive pulley; said at least two drive pulleys each having a drive shaft; said drive shaft having an upper frictional wheel along a length of said drive shaft and a lower frictional wheel at a terminal end of said drive shaft; wherein said upper and said lower frictional wheels spin freely from said drive shaft; said upper and said lower frictional wheels being in perpendicular orientation with said drive shaft; a ratchet cylinder spinning with said drive shaft, said ratchet cylinder sliding up or down said drive shaft to mesh with either said upper frictional wheel or said lower frictional wheel; a frictional disk, said fictional disk connecting to an axle to a left wheel and an opposing frictional disk connecting to an axle of a right wheel opposite said left wheel, wherein said frictional disk and said opposing frictional disk independently couple with said upper frictional wheel or said lower frictional wheel; wherein said frictional disk being in a perpendicular orientation with said upper and said lower frictional wheels; and wherein said ratcheting cylinder alternatively meshing with said upper or said lower frictional wheel causing said frictional disk to rotate in direction of least resistance corresponding to the rotational force of said upper or lower frictional wheel.
